(19) United States
(12) Patent Application Publication
(10) Pub. No.: US 2007/0176308 A1
(43) Pub. Date: Aug. 2, 2007

(54) Slat fill hanger for cooling towers and slat for use in same

(75) Inventor: Gregory Maury Shepherd, Houston, TX (US)

Correspondence Address: FOLEY AND LARDNER LLP;SUITE 500, 3000 K STREET NW, WASHINGTON, DC, 20007, US

(73) Assignee: C.E. SHEPHERD CO., INC.

(21) Appl. No.: 11/343,213

(22) Filed: Jan. 31, 2006

(51) Int. Cl. B01F 3/04

(52) U.S. Cl. 261/111; 261/DIG. 11

(57) ABSTRACT

A slat fill apparatus includes a hanger and at least one slat. The hanger includes a first plurality of support members oriented in a first direction; a second plurality of support members oriented in a second direction; and at least one slat retainer projecting from, and integrally formed with, one of the support members. The first and second pluralities of support members define at least one slat receiving channel into which the at least one slat retainer projects. The at least one slat is installed in a corresponding one of the slat receiving channels of the hanger.

### BACKGROUND

Cross-flow cooling towers typically incorporate a plurality of horizontally oriented surfaces, which collectively are referred to in the industry as slat fill or splash fill (hereinafter “slats”), to facilitate cooling of water by breaking and reforming falling droplets as they pass from the distribution level to the collection basin of the structure. The orientation of the slats may be either parallel or perpendicular to a direction of airflow and may have various spaces that separate them in a wide range of patterns.

The slats are suspended in these various configurations within the cooling tower by a support structure that is typically referred to as a slat fill hanger. The hanger can be made from various materials including wood, plastic, and metal. Further, although the slats are typically made of plastic, they also can be made from a variety of materials, which may be suitably molded to function in cooling towers.

Slats are positioned on the hanger, which locates and supports them in the path of the falling water within the tower. The impact that results from water impinging on the slats causes the slats to vibrate. Further, the more water impinging on the slats, the greater the vibration. Vibration of the slats causes abrasion between the slats and the support hanger. Periodic gusts and ice from undesirable weather contributions also cause abrasion. The abrasion erodes the hanger material and the slats, thereby shortening the useful life of the cooling tower. In addition to the frictional erosion caused by the falling water, turbulent airflow across the slats through the tower creates flutter that may cause erosion in the slats. In extreme circumstances, flutter can move, dislodge, and/or invert (collectively “displace”) the slats.

In light of such erosion and displacement, it is common practice in the industry to install a locking wear pad between a slat and the hanger, to reduce the ability for the slat to move within the hanger. The wear pads are generally made from thermoplastics such as polyolefin, which have good wear and friction reducing properties as well as structural properties that hold the slat fill in place. Unfortunately, the cost of installing the locking wear pads is high, as such installation is labor intensive. Specifically, installation of the locking wear pads increases the overall time of installing the slats in the hanger because clips associated with the locking wear pads interfere with installer's ability to slide the slats into position within the hanger.

In an effort to reduce the cost of the hanger and wear pads, hangers have been developed with wear pads integrated into the hanger structure. These integrated pads are injection molded with the hanger in a single unit from polyolefin. Although these integrated hangers eliminate the step of wear pad installation and, therefore, reduce labor costs associated with installation, these hangers do not offer the same load bearing capacity or durability as the welded wire fill hangers. Moreover, polyolefin thermoplastic hangers are naturally flammable and, therefore, require the addition of expensive fire retardants to meet fire codes, thereby reducing the savings associated with the cheaper installation costs.

In light of the aforementioned, it is desired to have a new apparatus and/or method by which vibration-reducing slat fill can be installed in a slat fill hanger at lower cost.

### SUMMARY

One embodiment of the present invention addresses a slat fill apparatus that includes, among other possible things: a hanger and at least one slat. The hanger includes, among other possible things: a first plurality of support members oriented in a first direction; a second plurality of support members oriented in a second direction; and at least one slat retainer projecting from, and integrally formed with, one of the support members. The first and second pluralities of support members define at least one slat receiving channel into which the at least one slat retainer projects. The at least one slat is installed in a corresponding one of the at least one slat receiving channel of the hanger.

In a further embodiment of this slat fill apparatus, the at least one slat retainer may be configured to bend along a first path when the at least one slat is installed in the slat receiving channel.

In another further embodiment of this slat fill apparatus, when a tip of the at least one slat passes the at least one slat retainer, the at least one slat retainer may be configured to spring elastically along a second path.

In another further embodiment of this slat fill apparatus, the at least one slat retainer may be configured to spring elastically onto or adjacent an outer surface of the at least one slat.

In another further embodiment of this slat fill apparatus, the first and second paths may be in substantially opposite directions.

In another further embodiment of this slat fill apparatus, the apparatus may include at least two slats. Further, the slats, when installed in the hanger, may be vertically and/or horizontally staggered with respect to each other.

In another further embodiment of this slat fill apparatus, the at least one slat may include at least one slot configured to receive the support member from which the at least one slat retainer projects. Further, the at least one slot may have an opening that has a width that is substantially the same size as a width of the support member received therein.

In another further embodiment of this slat fill apparatus, each of the at least one slot may have two substantially linear sides and an end portion that joins the sides.

In another further embodiment of this slat fill apparatus, the at least one slat retainer may be substantially parallel to a support member that supports the slat.

In another further embodiment of this slat fill apparatus, the at least one slat retainer may not be substantially parallel to a support member that supports the slat.

Another embodiment of the present invention addresses a cooling tower slat that includes, among other possible things, a plurality of installation slots that are configured to receive corresponding support members of a cooling tower hanger. The slots have openings that have widths that are substantially the same size as widths of the corresponding support members.

In a further embodiment of this cooling tower slat, the slat may have a gull-wing shaped cross-section.

Another embodiment of the present invention addresses a cooling tower slat that includes, among other possible things, a plurality of installation slots that are configured to receive corresponding support members of a cooling tower hanger. Each slot has two sides and an end that joins the sides.

In a further embodiment of this cooling tower slat, the slat may have a gull-wing shaped cross-section.

In another further embodiment of this cooling tower slat, the slots may have openings that have widths that are substantially the same size as widths of the corresponding support members.

In another further embodiment of this cooling tower slat, the two sides that are joined by the end may be substantially linear.

Another embodiment of the present invention addresses a hanger for a cooling tower slat fill apparatus. The hanger includes, among other possible things: a first plurality of support members oriented in a first direction; a second plurality of support members oriented in a second direction; and at least one slat retainer projecting from, and integrally formed with, one of the support members. The first and second pluralities of support members define at least one slat receiving channel. The at least one slat retainer is configured to bend along a first path when a slat is being installed in the hanger. When a tip of the slat passes the at least one slat retainer, the at least one slat retainer is configured to spring elastically along a second path.

In a further embodiment of this hanger, the at least one slat retainer may be configured to spring elastically onto or adjacent an outer surface of the at least one slat.

In another further embodiment of this hanger, the at least one slat retainer may project from one of the support members into one of the slat receiving channels.

In another further embodiment of this hanger, the first and second paths may be in substantially opposite directions.

Another embodiment of the present invention addresses a method of installing a slat in a hanger. This method includes, among other possible steps: providing a hanger that includes, among other possible things: a first plurality of support members oriented in a first direction; a second plurality of support members oriented in a second direction, wherein the first and second pluralities of support members define at least one slat receiving channel; and first and second slat retainers projecting from, and integrally formed with, the first and second pluralities of support members; inserting a slat in one of the slat receiving channels; aligning a first slot formed in the slat with the first slat retainer; bending the first slat retainer from a first rest position to a first activated position; positioning a first portion of an outer surface of the slat between a primary support member and the first slat retainer; and returning the first slat retainer to the first rest position.

In a further embodiment of this method, the method may additionally include the steps of: aligning a second slot formed in the slat with the second slat retainer; bending the second slat retainer from a second rest position to a second activated position; positioning a second portion of the outer surface of the slat between the primary support member and the second slat retainer; and returning the second slat retainer to the second rest position.

In another further embodiment of this method, the step of aligning a second slot formed in the slat with the second slat retainer may include the step of bending the slat substantially elastically.

In another further embodiment of this method, the step of positioning a second portion of the outer surface of the slat between the primary support member and the second slat retainer may include the step of rotating the slat.

In another further embodiment of this method, the slat may be inserted at an angle relative to the primary support member.

In another further embodiment of this method, the first slat retainer may bend substantially elastically.

In another further embodiment of this method, the second slat retainer may bend substantially elastically.

These and other features, aspects, and advantages of the present invention will become more apparent from the following description, appended claims, and accompanying exemplary embodiments shown in the drawings.

### BRIEF DESCRIPTION OF THE DRAWINGS

FIG. 1 is a top perspective view of an embodiment of a representative portion of a gull-wing slat according to the present invention;

FIG. 2 is a close-up elevation view of a portion of the gull-wing slat of FIG. 1 and a slot formed in the slat;

FIG. 3 is an elevation view of a hanger without any slats installed therein;

FIG. 4A is an elevation view of the hanger of FIG. 3 including two slats that have been partially installed therein at an angle;

FIG. 4B is an elevation view of the hanger and slats of FIG. 4A, the slats being partially rotated such that respective first and second slat retainers are elastically bent, the first slat retainers being bent to a greater degree than the second slat retainers;

FIG. 4C is an elevation view of the hanger and slats of FIGS. 4A-4B, the slats being partially rotated such that first slat retainers have outwardly sprung, under elastic force, onto the top sides of the slats and the second slat retainers are further elastically bent;

FIG. 4D is an elevation view of the hanger and slats of FIGS. 4A-4C, the slats being shown in the fully installed position such that the slats are positioned below the respective first and second slat retainers and above supports;

FIG. 5 is a perspective view of the hanger and slats of FIG. 4D along with a second hanger that also supports that the slats;

FIG. 6 is an elevation view of an alternate embodiment hanger; and

FIG. 7 is an elevation view of the hanger shown in FIG. 6 with a slat of the type shown in FIG. 1 fully installed therein.

### DETAILED DESCRIPTION

Presently preferred embodiments of the invention are illustrated in the drawings. An effort has been made to use the same reference numbers throughout the drawings to refer to the same or like parts.

Embodiments of the present invention create a welded wire slat fill support hanger with an integral slat locking feature that works in conjunction with the slats to secure the slats in the welded wire hanger grid, without the need to use, and thus install, a separate locking wear pad. The welded wire hanger is manufactured with a secondary wire slat retainer, which is integrally formed (e.g., molded or welded) immediately above a primary slat support wire. The secondary wire slat retainer is wide enough to contact or be adjacent an upper surface of the slat when it is resting on the primary support wire. The secondary slat retainer prevents the slat from being lifted off of the support wire and being displaced from its proper position in the hanger. As a result, the slat retainer minimizes slat erosion and flutter.

In some embodiments, the slat retainer can be bent onto the surface of the slat after the slat has been installed in the hanger. In other embodiments, the slat retainer elastically flexes while the slat is being installed and then springs outward onto a surface of the slat when the slat is completely installed. The slat retainer prevents the slat from fluttering in the turbulent airflow that is drawn through the fill bay area. As a result, this integrated hold down slat retainer eliminates the need for additional labor time and associated expenses of installing a separate component. At the same time, the integrated hold down slat retainer, in conjunction with a novel (described herein) or conventional gull-wing style slat, allows rapid installation of the slat in the hanger. The novel gull-wing slat allows maximum surface area contact with the primary hanger support wire, thereby minimizing wear and erosion of the contact surfaces.

In some embodiments, the installation of the slats and the resting of the inverted V-shaped center rib on the primary slat support wire of the hanger are enabled as follows. The height of the center rib and the overall width of the slat allows the slat to slide through each of the hangers at an angle. When the slat is fully inserted, it is rotated (e.g., by about 45°) to its normal orientation in the hangers. Fill edge locating slots of the slat are then positioned directly around adjacent support wires of the hangers that are oriented normal to the slat. In so rotating, the slat rests flat against the primary (parallel) slat support wire and beneath the secondary slat retainers. As previously mentioned, the slat retainers can then be bent down to lock and hold the slat or may elastically spring to lock and hold the slat, thereby minimizing movement within the hanger.

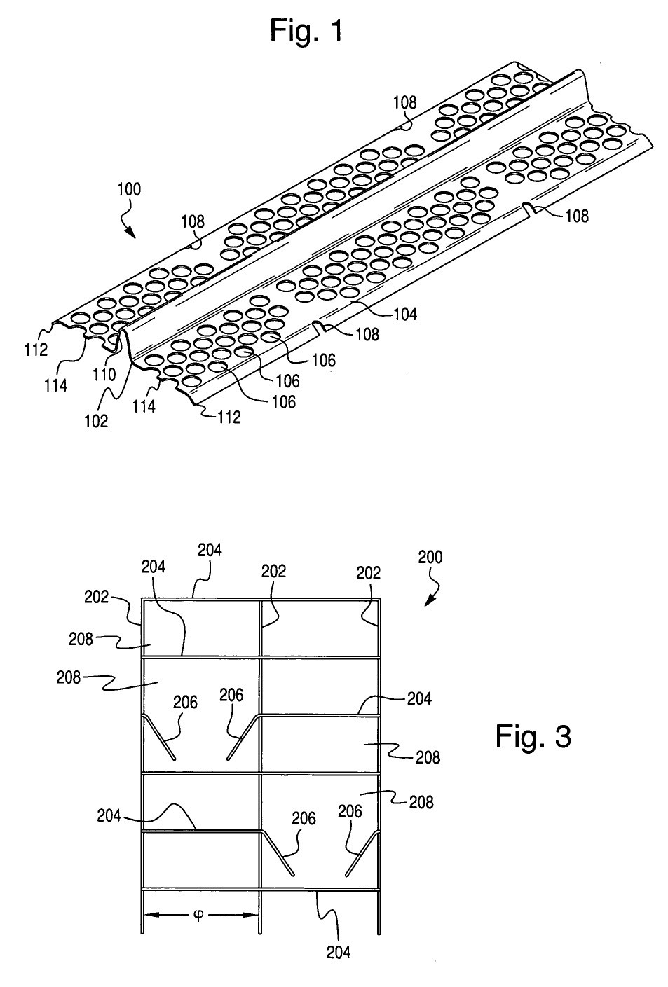

An embodiment of a slat 100 according to the present invention is shown FIG. 1. The slat 100 has a conventional gull-wing cross-section 102. The gull-wing cross-section 102 extends between wing tips 112 and includes wings 114 and an inverted V-shaped center rib 110.

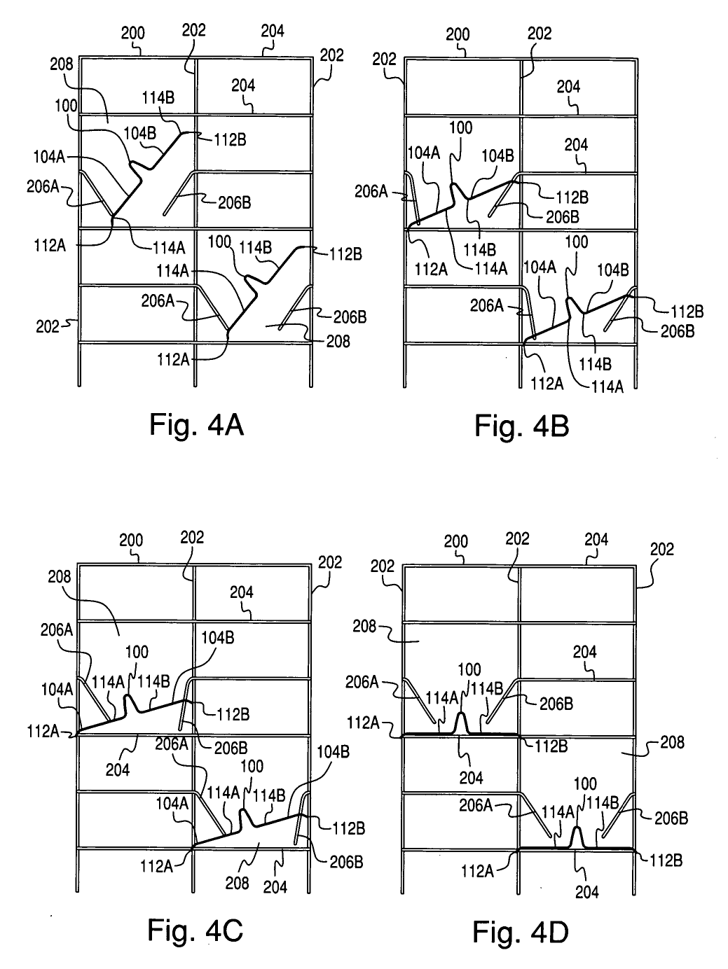

When the slat 100 is installed in a cooling tower hanger 200, 400 (as later described), water falling through the cooling tower collides with the top surfaces 104 of the wings 114. Whereas some of the water on the wings 114 rolls off the wing tips 112, most of the water on the wings 114 falls through a plurality of holes 106 formed in the wings 114. In both instances, the separation of the water on the wings 114 facilitates cooling of the water. This process is repeated with numerous other slats 100 in the cooling tower. The slats 100 in such cooling towers may be, as shown in FIGS. 4D and 7, offset vertically and/or horizontally. The offset nature of the slats 100 creates a chaotic path for the falling water; such a chaotic path further facilitates cooling of the water.

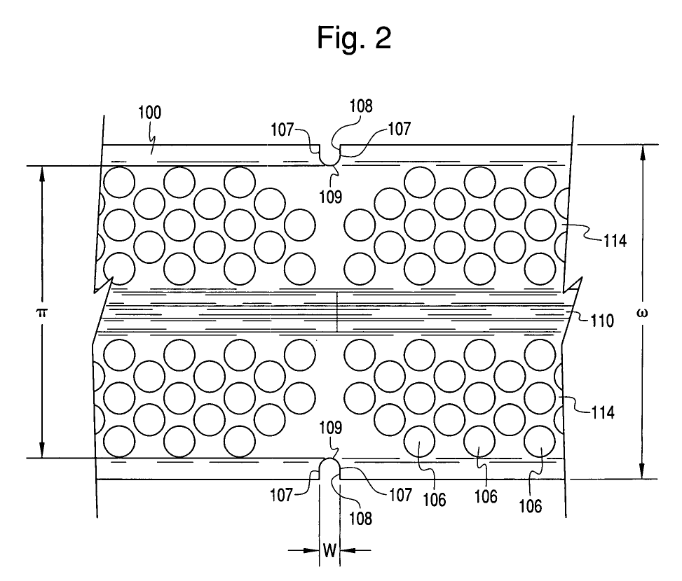

Unlike the generally circular slots of conventional gull-wing style slats, the slat 100 shown in FIG. 1 includes U-shaped slots 108. Two such U-shaped slots 108 are shown in FIG. 2. The slots 108 have two generally parallel and substantially linear sides 107 that are connected by a rounded end 109. The sides 107 of the slots 108 are separated by a width W that is substantially equal to the diameter of a support member 202, 402 of the hanger 200, 400 that is to be received by the slot 108, as later described in detail.

The slat 100 may be formed, for example, from a variety of materials such as wood, plastics, and metals. By way of specific example, the slat 100 may be formed from an uncoated metal (e.g., aluminum, tin, nickel, etc.) or an uncoated combination of metals (e.g., steel or an alloy). Similarly, the slat 100 may also be formed of a plastic such as a polyolefin (e.g., polyethylene, polypropylene, polyester, polyurethane, etc.). Moreover, in some embodiments, the slat 100 may be formed of a metal (or combination of metals) coated with a polymer.

Hangers 200, one of which is shown in FIG. 3, may be formed from the same materials as the slat 100. Moreover, in some embodiments, the slats 100 may be formed of a plastic and the hangers 200 may be formed of a plastic coated metal (or combination of metals).

Each of the hangers 200 includes a first plurality of support members 202 and a second plurality of support members 204. Together, the first and second pluralities of support members 202, 204 define at least one slat receiving channel 208. As shown in FIG. 3, the first plurality of support members 202 may be generally vertically oriented and the second plurality of support members 204 may be generally horizontally oriented. As a result, the first and second pluralities of support members 202, 204 define a plurality of slat receiving channels 208.

Slat retainers 206 are provided in some of the slat receiving channels 208. Each of the slat retainers 206 is integrally formed (molded or welded) with one of the support members 202, 204. For example, and as shown, the slat retainers 206 may be integrally formed with the second plurality of support members 204.

Depending on the material(s) from which the slat retainers 206 are formed, the retainers 206 may be either deformably bendable or elastically bendable. For example, the retainers 206 can be formed of a plastic material that can be deformably bent into a variety of shapes such that when the bending force is removed, the retainers 206 retain their bent shape. By way of further example, the retainers 206 can be formed of a metal (or plastic coated metal) that can be elastically bent such that when the bending force is removed, the retainers 206 return to their original unbent shape.

As shown in FIG. 4A, the slat receiving channels 208 are configured to receive slats 100. To insert the slats 100 into the slat receiving channels 208, the slats 100 are rotated to be at an angle with respect to the second support members 204 onto which the slats 100 are ultimately to rest. When the slats 100 are fully inserted (at an angle) through the hanger 200, the slats 100 are rotated. Initially, as shown in FIG. 4B, first slat retainers 206A are bent to a greater degree than second slat retainers 206B. Subsequently, as shown in FIG. 4C, after the wing tips 112A associated with the first slat retainers 206A pass the first slat retainers 206A to such a degree that the wings 114A are positioned below the ends of the first slat retainers 206A, the first slat retainers 206A will either elastically return or be configured to be bent onto (or adjacent) the top surfaces 104A of the wings 114A. Simultaneously, the rotation of the slats 100 causes a further bending of the second slat retainers 206B. Finally, as shown in FIG. 4D, after the wing tips 112B associated with the second slat retainers 206B pass the second slat retainers 206B to such a degree that the wings 114B are positioned below the ends of the second slat retainers 206B, the second slat retainers 206B will either elastically return or be configured to be bent onto (or adjacent) the top surfaces 104B of the wings 114B.

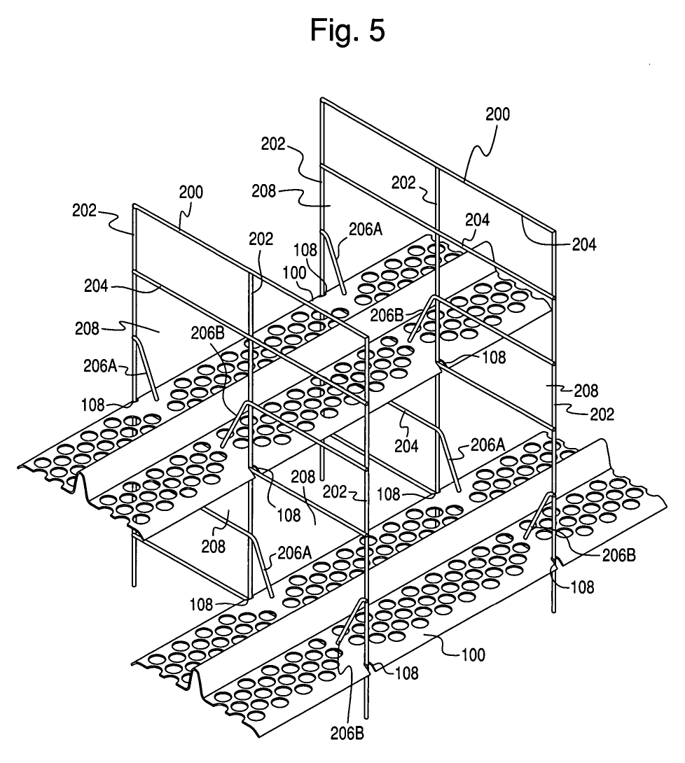

It should be recognized that the slats 100 have overall widths ω (FIG. 2) that are wider that the widths φ (FIG. 3) of the slat receiving channels 208. To enable the gull-wing slats 100 to fit within the slat receiving channels 208 when installed, the slots 108 are provided. Specifically, as shown in FIG. 2, the rounded ends 109 of opposed slots 108 are separated by a distance π that is substantially equal to the width φ of the slat receiving channels 208. As a result, when the slats 100 are installed in the hanger 200, the slots 108 are configured to envelop three sides of the support members 202 that intersect the support members 204 on which the slats 100 rest. In addition, unlike conventional circular slots (in which a support member can readily move), the widths W of the U-shaped slots 108 are substantially the same size as the widths (diameter) of the support members 202 received therein, thereby rigidly engaging the slats 100 and the support members 202; this feature is best shown in FIG. 5. As a result, this U-shaped design contributes to substantially eliminating the erosion and flutter suffered by the prior art.

As the wings 114A, 114B of the slats 100 are positioned below the slat retainers 206A, 206B, as the wings 114A, 114B rest on support members 204, and as the slots 108 are rigidly engaged with the support members 202, the slats 100 are locked in position in the hangers 200. As a result, the slats 100 can not be displaced by, e.g., wind or ice, with respect to the hanger 200. Moreover, due to the immobility of the slats 100 with respect to the hanger 200, the slats 100 and the hanger 200 do not suffer the extent of the erosion problems that have plagued conventional cooling tower slats and hangers.

Of course, if a technician wants to replace the slats 100, the technician can simply reverse the installation process. In other words, to remove the slats 100, the technician can: (a) bend one of the slat retainers 206B to such a degree that the associated wing 114B can pass that slat retainer 206B when the slat 100 is rotated; (b) rotate the slat 100 in a direction that is the reverse from the direction in which the slat 100 was rotated to install it; (c) clear the other wing 114A from the other slat retainer 206A; and (d) pull the slat 100, at an angle, out of the hanger 200.

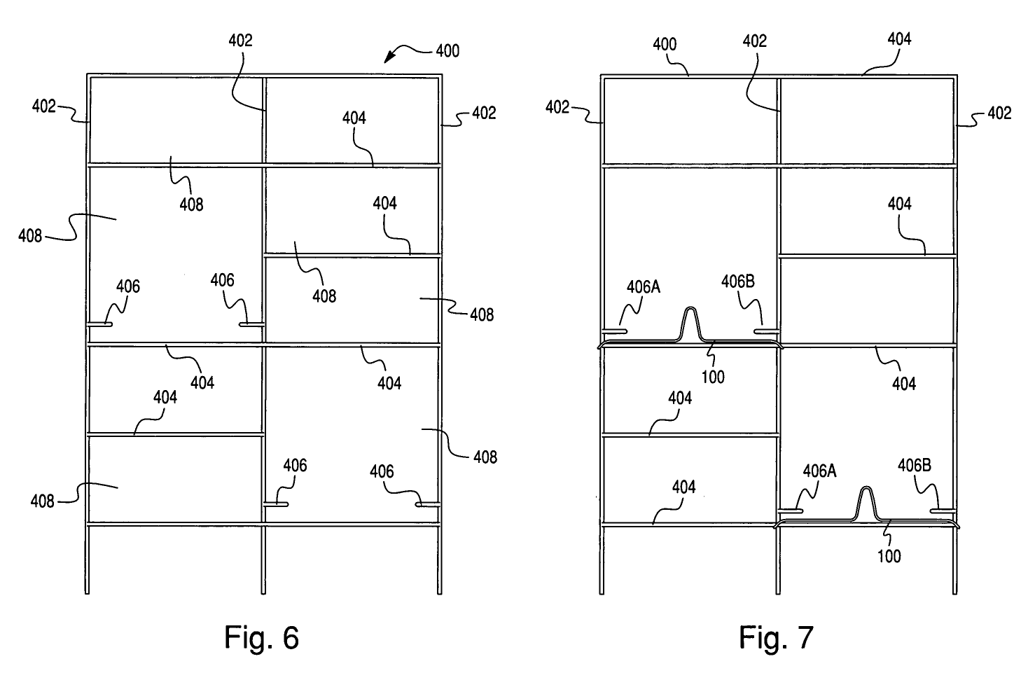

FIG. 6 depicts an alternate embodiment hanger 400. Similar to the previously described hanger 200, this hanger 400 is formed of a plurality of first support members 402 and a plurality of second support members 404; together the first and second pluralities of support members 402, 404 define at least one slat receiving channel 408. Also similar to the previously described hanger 200, this hanger 400 includes a plurality of slat retainers 406, each of which is integrally formed (molded or welded) with one of the supports 402, 404.

Unlike the slat retainers 206 of the previously described hanger 200, the slat retainers 406 are shorter and are provided closer to the support members 404 on which the slats 100 rest, as shown in FIG. 7. The installation of the slats 100 in this hanger 400 is substantially the same as the installation of the slats 100 in the previously described hanger 200 and, therefore, a duplicative discussion thereof will be omitted.

With respect to both of the aforementioned hangers 200, 400, if the slats 100 are formed of a flexible material such as plastic, the slats 100 may be squeezed somewhat during installation to compress the inverted V-shaped center rib 110. By squeezing the slats 100 to bring the ends 112 closer together, two potential benefits arise. First, the slats 100 may slide through the slat receiving channels 208 easier. Second, the rotation of the slats 100 into the installed position (FIG. 4D, FIG. 7) may be easier.

Both the aforementioned hangers 200, 400 enjoy particular advantages. For example, the slat retainers 206 of the first hanger 200 may easily be molded with the support members 204, thereby reducing the labor costs associated with constructing the hanger 200. Specifically, each pair of the slat retainers 206A, 206B may be formed by cutting one of the horizontal support members 204 at a central position with respect to a slat receiving channel 208 followed by bending the slat retainers 206A, 206B downward into their rest position before molding is complete. By way of another example, as the slat retainers 406 of the second hanger 400 are shorter than the slat retainers 206 of the first hanger 200, the cost of raw materials necessary to construct the hanger 400 may be reduced. As a result, one may decide to construct one of the hangers (e.g., hanger 200) rather than the other hanger (e.g., 400) after balancing the cost of the raw materials and the cost of labor to construct the hanger.

Although the aforementioned describes embodiments of the invention, the invention is not so restricted. It will be apparent to those skilled in the art that various modifications and variations can be made to the disclosed embodiments of the present invention without departing from the scope or spirit of the invention. These modifications and variations are fully within the scope of the invention. Therefore, it should be understood that the apparatuses and methods described herein are illustrative only and are not limiting upon the scope of the invention, which is indicated by the following claims.

What is claimed is:

1. A slat fill apparatus comprising:
a hanger comprising:
a first plurality of support members oriented in a first direction;
a second plurality of support members oriented in a second direction; and
at least one slat retainer projecting from, and integrally formed with, one of the support members,
wherein the first and second pluralities of support members define at least one slat receiving channel into which the at least one slat retainer projects; and
at least one slat installed in a corresponding one of the at least one slat receiving channel of the hanger.

2. The slat fill apparatus according to claim 1, wherein the at least one slat retainer is configured to bend along a first path when the at least one slat is installed in the slat receiving channel.

3. The slat fill apparatus according to claim 2, wherein, when a tip of the at least one slat passes the at least one slat retainer, the at least one slat retainer is configured to spring elastically along a second path.

4. The slat fill apparatus according to claim 3, wherein the at least one slat retainer is configured to spring elastically onto or adjacent an outer surface of the at least one slat.

5. The slat fill apparatus according to claim 3, wherein the first and second paths are in substantially opposite directions.

6. The slat fill apparatus according to claim 1, wherein the apparatus comprises at least two slats, and wherein the slats, when installed in the hanger, are vertically and/or horizontally staggered with respect to each other.

7. The slat fill apparatus according to claim 1,
wherein the at least one slat comprises:
at least one slot configured to receive the support member from which the at least one slat retainer projects, and
wherein the at least one slot has an opening that has a width that is substantially the same size as a width of the support member received therein.

8. The slat fill apparatus according to claim 7, wherein each of the at least one slot has two substantially linear sides and an end portion that joins the sides.

9. The slat fill apparatus according to claim 1, wherein the at least one slat retainer is substantially parallel to a support member that supports the slat.

10. The slat fill apparatus according to claim 1, wherein the at least one slat retainer is not substantially parallel to a support member that supports the slat.

11. A cooling tower slat comprising:
a plurality of installation slots that are configured to receive corresponding support members of a cooling tower hanger,
wherein the slots have openings that have widths that are substantially the same size as widths of the corresponding support members.

12. The cooling tower slat according to claim 11, wherein the slat has a gull-wing shaped cross-section.

13. A cooling tower slat comprising:
a plurality of installation slots that are configured to receive corresponding support members of a cooling tower hanger,
wherein each slot has two sides and an end that joins the sides.

14. The cooling tower slat according to claim 13, wherein the slat has a gull-wing shaped cross-section.

15. The cooling tower slat according to claim 13, wherein the slots have openings that have widths that are substantially the same size as widths of the corresponding support members.

16. The cooling tower slat according to claim 13, wherein the two sides that are joined by the end are substantially linear.

17. A hanger for a cooling tower slat fill apparatus, the hanger comprising:
a first plurality of support members oriented in a first direction;
a second plurality of support members oriented in a second direction; and
at least one slat retainer projecting from, and integrally formed with, one of the support members,
wherein the first and second pluralities of support members define at least one slat receiving channel,
wherein the at least one slat retainer is configured to bend along a first path when a slat is being installed in the hanger, and
wherein, when a tip of the slat passes the at least one slat retainer, the at least one slat retainer is configured to spring elastically along a second path.

18. The hanger according to claim 17, wherein the at least one slat retainer is configured to spring elastically onto or adjacent an outer surface of the at least one slat.

19. The hanger according to claim 17, wherein the at least one slat retainer projects from one of the support members into one of the slat receiving channels.

20. The hanger according to claim 17, wherein the first and second paths are in substantially opposite directions.

21. A method of installing a slat in a hanger, comprising the steps of:
providing a hanger comprising:
a first plurality of support members oriented in a first direction;
a second plurality of support members oriented in a second direction, wherein the first and second pluralities of support members define at least one slat receiving channel; and
first and second slat retainers projecting from, and integrally formed with, the first and second pluralities of support members;
inserting a slat in one of the slat receiving channels;
aligning a first slot formed in the slat with the first slat retainer;
bending the first slat retainer from a first rest position to a first activated position;
positioning a first portion of an outer surface of the slat between a primary support member and the first slat retainer; and
returning the first slat retainer to the first rest position.

22. The method according to claim 21, further comprising the steps of:
aligning a second slot formed in the slat with the second slat retainer;
bending the second slat retainer from a second rest position to a second activated position;
positioning a second portion of the outer surface of the slat between the primary support member and the second slat retainer; and
returning the second slat retainer to the second rest position.

23. The method according to claim 22, wherein the step of aligning a second slot formed in the slat with the second slat retainer, comprises the step of:
bending the slat substantially elastically.

24. The method according to claim 22, wherein the step of positioning a second portion of the outer surface of the slat between the primary support member and the second slat retainer comprises the step of:
rotating the slat.

25. The method according to claim 21, wherein the slat is inserted at an angle relative to the primary support member.

26. The method according to claim 21, wherein the first slat retainer bends substantially elastically.

27. The method according to claim 22, wherein the second slat retainer bends substantially elastically.
